(19) United States
(12) Patent Application Publication
(10) Pub. No.: US 2002/0120664 A1
(43) Pub. Date: Aug. 29, 2002

(54) Scalable transaction processing pipeline

(76) Inventors: Robert L. Horn, Yorba Linda, CA (US); Virgil V. Wilkins, Perris, CA (US); Mark D. Myran, Lake Forest, CA (US); David S. Walls, Aliso Viejo, CA (US); Gnanashanmugam Elumalai, Irvine, CA (US); U?apos;Tee Cheah, Loma Linda, CA (US)

Correspondence Address: LYON & LYON LLP, 633 WEST FIFTH STREET, SUITE 4700, LOS ANGELES, CA, 90071, US

(21) Appl. No.: 09/739,354

(22) Filed: Dec. 15, 2000

Related U.S. Application Data
(60) Provisional application No. 60/252,839, filed on Nov. 17, 2000.

(51) Int. Cl. G06F 9/00

(52) U.S. Cl. 709/107

(57) ABSTRACT

A system for processing a plurality of tasks is disclosed. Each task has a plurality of component subtasks. The system may process N tasks and each task includes a first subtask, and a second subtask. The system for processing the plurality of tasks comprises a scalable transaction processing pipeline (STPP). The STPP comprises a plurality of processing elements, including at least a first processing element and a second processing element, the first processing element is adapted to process the first subtask of each task. The second processing element is adapted to process the second subtask of each task. Each successive processing element is adapted to process a corresponding subtask or subtasks of each task. The first processing element processes the first subtask of each task. When the first processing element finishes the processing of the first subtask, the second processing element processes the second subtask of each task. The STPP further includes a plurality of data structures and a plurality of data managers. Each data manager is adapted to manage a data structure. An interconnect couples each processing element to at least one data manager. The interconnect manages the data flow between the interconnect and the processing elements, and between the interconnect and the data managers.

### RELATED APPLICATIONS

This application is based on provisional patent application serial No. 60/252,839 filed Nov. 17, 2000.

### BACKGROUND OF THE INVENTION

1. Field of the Invention

The invention is a system for processing a plurality of tasks. Specifically, the invention is a scalable transaction processing pipeline (STPP) for processing a plurality of tasks, each of the tasks having subtasks that are each processed by a different processing element.

2. Description of the Prior Art and Related Information

Current and prior transactional processing computers and systems receive tasks from host computers or processors and execute software to process the tasks. Each task may comprise a plurality of subtasks that must be completed to process the task as a whole. As each task is received, the transactional processing computer processes each sub-task sequentially by re-configuring the processor for each subtask, branching to a different set of instructions to process each subtask.

As processing volumes have increased in transactional processing systems, the number of tasks and subtasks have increased dramatically. Even with recent advances in processor speeds, backlogs in processing tasks still mount in many transactional processing systems. The traditional model of re-configuring the processor of the transactional processing system for each subtask is increasing becoming a limiting process as volume increases.

One solution that has been employed is to provide more than one processor to the transactional processing computer. However, each processor still requires time for re-configuration for processing the tasks or subtask which it is assigned. This technique does not relieve the need for re-configuration of each processor to process each subtask. Further, rarely is it possible to process subtasks out of sequence and maintain integrity in the process. Further, typical parallel processing adds overhead for managing completion of subtasks.

### SUMMARY OF THE INVENTION

The system of the present invention solves the problems of current and prior systems described above.

A system for processing a plurality of tasks is disclosed. The system may process N tasks and each task may include as many as M subtasks. The system for processing the plurality of tasks comprises a scalable transaction processing pipeline (STPP).

The STPP comprises a plurality of processing elements, including at least a first processing element and a second processing element, the first processing element is adapted to process the first subtask of each task. The second processing element is adapted to process the second subtask of each task. If there are more than two processing elements, each successive processing element is adapted to process a corresponding subtask or subtasks of each task.

The first processing element processes the first subtask of each task. When the first processing element finishes the processing of the first subtask, the second processing element processes the second subtask of each task.

The STPP further includes a plurality of data structures and a plurality of data managers. Each data manager is adapted to manage a data structure.

An interconnect couples each processing element to at least one data manager. The interconnect may include a partial crosspoint interconnect or any type of crossbar known to those skilled in the art. The interconnect manages the data flow between the interconnect and the processing elements, and between the interconnect and the data managers. Packets being transferred to and from the interconnect may be stored in a first-in-first-out stack (FIFO).

The interconnect may support asynchronous messaging (AMe). AMe provides a way for a data manager to send command packets to the processing element. The command for facilitating messaging comprises, for example, a header and a set/clear word. The asynchronous message command is preferably a byte wide. Further preferably, eight bits of the set/clear word determine the setting of the asynchronous message, and the other 8-bits of the word determine the clearing of the AMe. Each time a new AMe modification takes place, a flag bit, AM flag, may be set to indicate to the processing element that a new asynchronous message exists. The processing element can poll the bit if desired.

At least one of the data structures may comprise a list, wherein at least one data manager is optimized to manipulate the list.

At least one of the data structures may comprise a table, wherein at least one data manager is optimized to manipulate the table.

The processing elements may send packets to the data managers via the interconnect. The packets may contain list or table manipulation commands.

The second processing element may be adapted to process the second subtask of a task while the first processing element processes the first subtask of a next task. Thus, each processing element may be optimized to process a subtask of each task. Each processing element may be adapted for processing a different subtask of each task.

Each of the above aspects are separate aspects, any individual one or any combination of which may be present in the invention.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts throughout the different views.

FIG. 1 is a block diagram illustrating a data flow into a scalable transactional processing system for processing a plurality of tasks, each task having a plurality of component subtasks.

FIG. 2 is a block diagram illustrating the components of an example of the scalable transactional processing system of FIG. 1.

FIG. 3 is a flow diagram illustrating the steps of a method performed by the system of FIGS. 1-2.

FIG. 4 is a block diagram illustrating a data structure associated with each data manager of FIG. 2.

FIG. 5 is a block diagram illustrating a structure of a table of FIG. 4.

FIG. 6 is a block diagram illustrating a structure of a forward linked list, which may comprise a table of FIG. 5.

FIG. 7 is a block diagram illustrating a double linked list, which may comprise a table of FIG. 5.

FIG. 8 is a block diagram showing the structure of an indirect list, which may comprise the table of FIG. 5.

FIG. 9 is a block diagram illustrating an example structure of a multiple list, which may comprise the table of FIG. 5.

FIG. 10 is a block diagram illustrating another use for the capability of the list of FIG. 9, which allows linking of same entries in the list in different orders.

FIGS. 11-13 are block diagrams illustrating an example of free list usage.

FIG. 14 is a block diagram illustrating examples of command and response packets used in the system of FIG. 2.

FIG. 15 is a block diagram illustrating an exemplary header for a command packet or response code packet of FIG. 14.

FIG. 16 is a block diagram illustrating an example structure of a response code packet of FIG. 14.

FIG. 17 is a block diagram illustrating an example of an asynchronous message response code.

FIG. 18 illustrates a plurality of fields for the lists of FIGS. 5-13 packed in memory on byte boundaries.

FIG. 19 is a block diagram illustrating an example of a table entry that supports a list with a key field, and a list with separate links and base and span fields.

FIG. 20 is a block diagram illustrating an example structure of a data manager of FIG. 2.

FIG. 21 is a block diagram illustrating the components of a processing element of FIG. 2.

FIG. 22 is a block diagram illustrating an example interface to the interconnect of the processing element of FIG. 21.

### DETAILED DESCRIPTION OF THE PREFERRED EMBODIMENTS

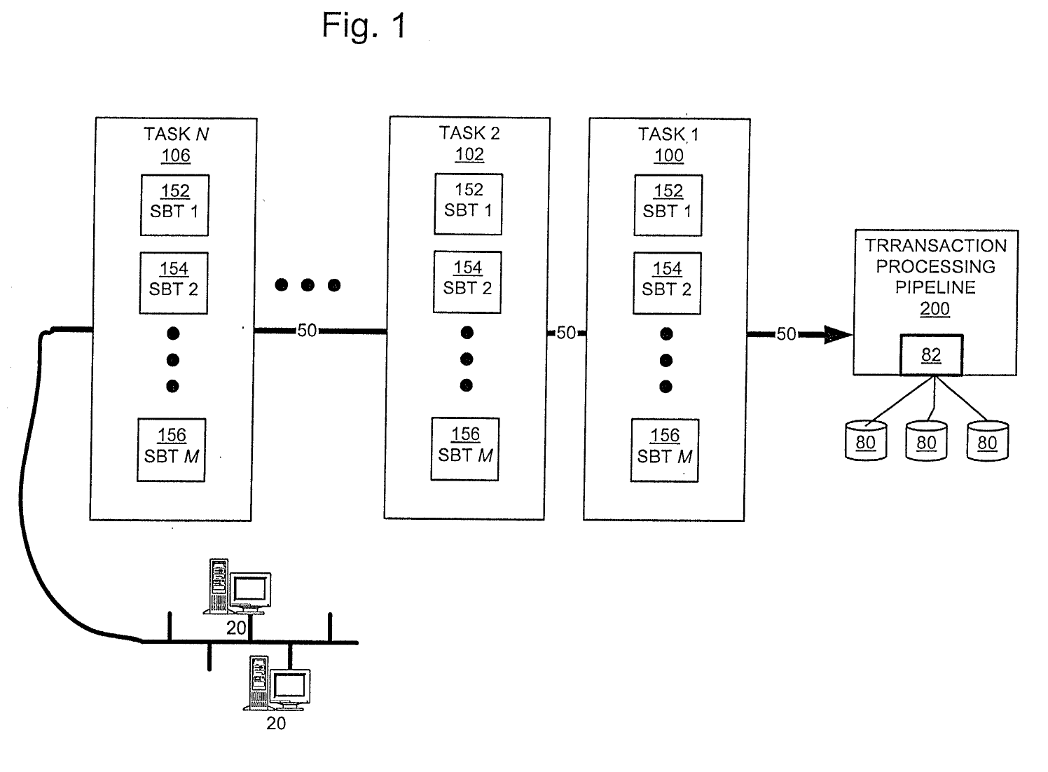

FIG. 1 illustrates a block diagram of a data flow into a system for processing a plurality of tasks 100-106, each task 100-106 having a plurality of component subtasks 152-156. The system may process Ntasks 100-104, and each task 100-104 includes a first subtask 152, and a second subtask 154. The tasks are received from a network input or interface 50. The network may comprise a local network, wide area network, switched fabric network, or the like. Each task 100 may have as many as M subtasks 152-156. Although the subtask 152 of task 100 is given the same reference number as subtask 152 of task 102, they can be different subtasks; the use of the same reference numural indicates that they are both the first subtasks of a task. The system for processing the plurality of tasks 100-104 comprises a scalable transaction processing pipeline (STPP) 200.

The tasks 100-104 may be selected from the group comprising: redundant array of independent disks (RAID) requests; queue management commands, cache data request, read data requests, write data requests, block level read requests, block level write requests, file level data read requests, file level data write requests, directory structure commands, and database manipulation commands from a storage management system comprising one or more disk drives 80. However, one skilled in the art would recognize that the system may be used in many other contexts. For example, the STPP 200 system may be used to process requests to one or more printers on a print server.

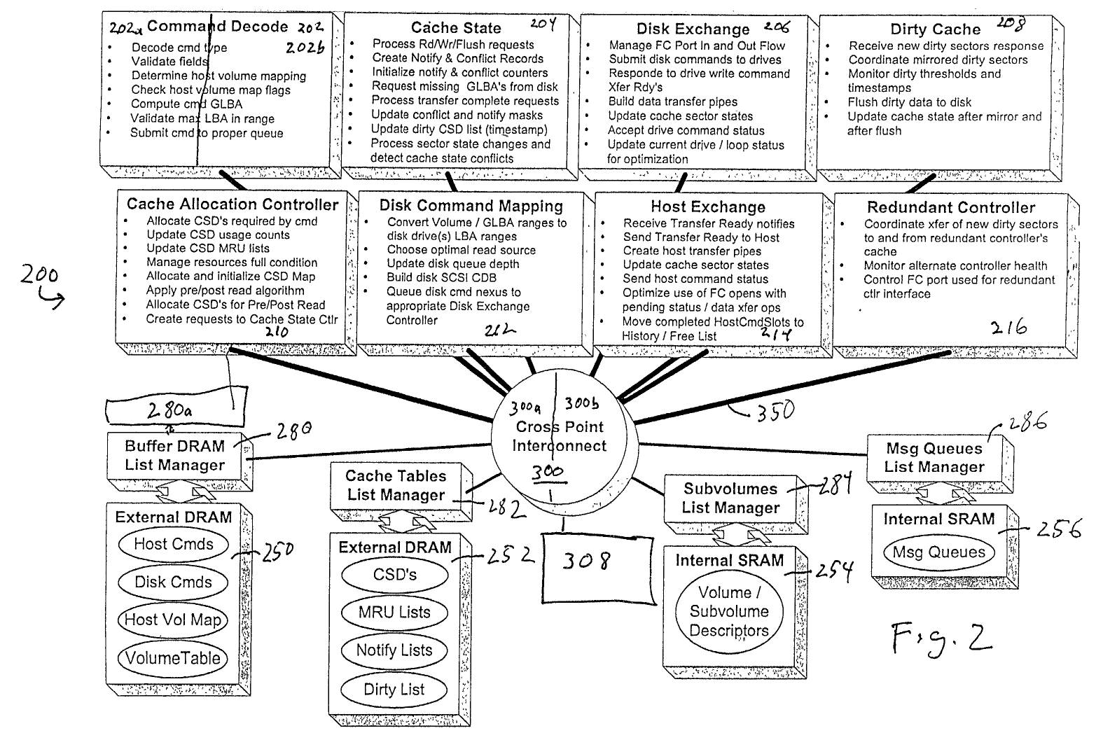

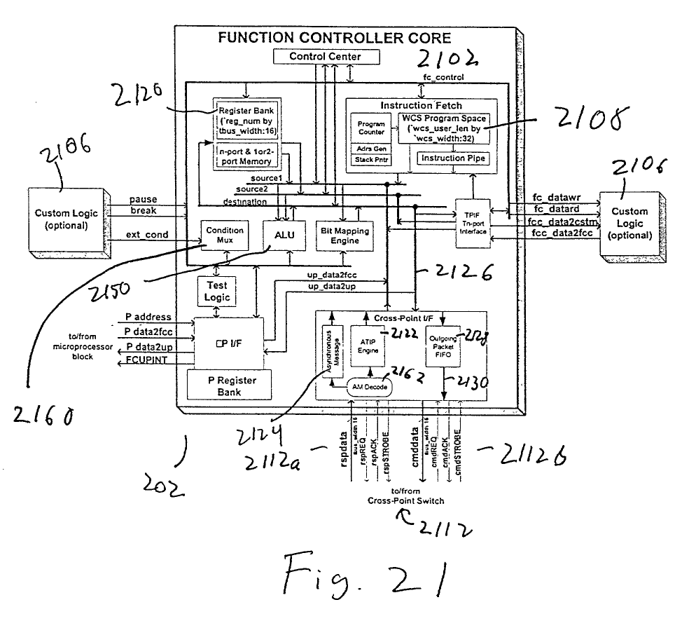

With reference to FIG. 2, the STPP 200 comprises a plurality of processing elements 202-216, including at least a first processing element 202 and a second processing element 204, the first processing element 202 is adapted to process the first subtask (152 of FIG. 1) of each task 100-104. The second processing element 204 is adapted to process the second subtask 154 of each task 100-104. Each successive processing element 206-216 is adapted to process a corresponding subtask or subtasks 152-156 of each task 100-104. For example, in a system wherein the tasks comprise commands from hosts computers for processing data in a data storage system comprising one or more disk drives, one processing element 202 may be adapted to process a subtask for decoding each command. Another processing element 204 may be adapted to process cache state commands, including processing read, write, and flush requests, or processing sector state changes and detecting cache state conflicts. Another processing element 206 may be adapted for processing disk exchange commands, such as commands for submitting disk commands to disk drives, or building data transfer pipes. Another processing element 208 may be adapted for processing subtasks comprising dirty cache commands, such as commands for flushing dirty data to disk drives. Another processing element 210 may be adapted for processing subtasks comprising cache allocation controller operations such as allocating cache state directories required by the task or command. Another processing element 212 may be adapted for processing subtasks comprising disk command mapping including converting volume and global logical byte address ranges to logical byte address ranges for disk drives. Another processing element 214 may be adapted to process subtasks such as host exchange processes including receiving transfer ready notifications. Another processing element 216 may be adapted to process subtasks comprising redundant controller operations such as monitoring mirrored controller functions. Each of the processing elements 202-216 preferably comprises a general processor known to those skilled in the art, programmed for the specific functionality for the task it is adapted to process with a set of executable instructions stored in a writeable control storage memory described with respect to FIG. 21 below.

The first processing element 202 processes the first subtask 152 of each task 100-104. When the first processing element 202 finishes the processing of the first subtask 152, the second processing element 204 processes the second subtask 154 of each task 100-104.

The STPP 200 further includes a plurality of data structures 250-256 and a plurality of data managers 280-286. Each data manager 280-286 is adapted to manage a data structure 250-2256. In the context of a data storage system in the example above, some of the data structures may comprise a buffer 250, a cache table 252, a sub-volume list 254, or a message queue 256. The data structures 250-256 stored each in an internal memory within the STPP 200 or in a memory external to the STPP 200 through a memory bus connection or other coupling means.

An interconnect 300 couples each processing element 202-216 to at least one data manager 280-286. The interconnect 300 may include a partial crosspoint interconnect or any other crossbar known to those skilled in the art. The interconnect 300 manages the data flow between the interconnect 300 and the processing elements 202-216, and between the interconnect 300 and the data managers 280-286. A FIFO 308 stores packets being transferred to and from the interconnect 300. The FIFO 308 also contains an extra bit for each word in the FIFO 308 that indicates the last word of packets (used for communication in the STPP 200 as described below). When the bit is a one, the associated word is the last in a packet.

The interconnect 300 may support asynchronous messaging (AMe). AMe provides a way for a data manager 280-286 to send command packets to the processing element 202-216. The command for facilitating messaging consists of a header and a set/clear word. Preferably, the asynchronous message command is a byte wide. Eight bits of the set/clear word determine the setting of the asynchronous message, and the other 8-bits of the word determine the clearing of the AMe. Each time a new AMe modification takes place, a flag bit, AM flag, is set to indicate to the processing element that a new asynchronous message exists. The processing element can poll the bit as desired.

At least one of the data structures 250-256 may comprise a list, wherein at least one data manager 280-286 is optimized to manipulate the list.

At least one of the data structures 250-256 may comprise a table, wherein at least one data manager 280-286 is optimized to manipulate the table.

The processing elements 202-216 may send packets to the data managers 280-286 via the interconnect 300. The packets may contain list or table manipulation commands.

The second processing element 204 may be adapted to process the second subtask 154 of a task 100 while the first processing element 202 processes the first subtask 152 of a next task 102. Thus, each processing element 202-216 may be optimized to process a subtask 152-156 of each task 100-104. Each processing element 202-216 may be adapted for processing a different subtask 152-156 of each task 100-104.

Each data manager 280-286 may be optimized to manage one of data structures 250-256.

Two or more processing elements 202-216 may comprise a first subset of the plurality of processing elements 204, 208 and 210. For example, said first subset 204, 208 and 210 may be adapted for processing a selected subtask 154 of the plurality of subtasks 152-156, wherein each processing element of the first subset 204, 208 and 210 is adapted to process a portion of the selected subtask 154. As another example, the subtask 154 may be a cache management process that can be divided into three separate sub-processes: cache state processing, dirty cache processing, and cache allocation processing. One of the processing elements of the subset 204 may be adapted to complete the cache state processing. Another processing element of the subset 208 may be adapted to complete the dirty cache processing, and third processing element 210 may be adapted to complete the cache allocation processing.

The interconnect 300 comprises hardware, including an electronic interface, and switching firmware/software, and may comprise a first and second interconnect 300a-300b. At least one of the processing elements 202, 204, 210 and 212 may be coupled to the first interconnect 300a, and at least one data manager 284 and 286 may be coupled to the second interconnect 300b, wherein the first interconnect 300a is coupled to the second interconnect 300b, thereby coupling the at least one processing element 202, 204, 210 and 212 coupled to the first interconnect 300a with the at least one data manager 284 and 286 coupled to the second interconnect 300b.

In one embodiment, the STPP 200 is for processing a plurality of ordered tasks_{1 to N}, 100-104, where each taskₙ 100-104 has a plurality of ordered subtasks_{1 to M} 152-156. Each subtaskₘ 152-156 is processed by at least one processing elementₘ 202-216 of a plurality of processing elements_{1 to M} 202-216. For example, while a processing elementₘ 202 processes a subtaskₘ 152 of a taskₙ₊₁ 102, a processing elementₘ₊₁ 204 processes a subtaskₘ₊₁ 154 of a taskₙ 100, wherein the taskₙ 100 is the task immediately preceding the taskₙ₊₁ 102, and wherein the subtaskₘ 152 is the subtask immediately preceding the subtaskₘ₊₁ 154.

A second subset of the plurality of processing elements 202a-202b may be adapted to process one of the plurality of subtasks 152 for a plurality of tasks 100-102 in parallel. In this way, processing of the same subtask 152 for two tasks 100-102 may be accelerated.

At least one of the processing elements 202 may be used to decode commands, the decoding of commands being one of the subtasks 152.

At least one data structure 252 may be a cache state, wherein at least one of the processing elements 204 controls a cache state 252.

At least one of the processing elements 212 may map data addresses to logical block addresses of a disk drive 80.

At least one of the processing elements 214 may interact with one or more host computers (20 in FIG. 1).

One of the tasks 152-156 may include a request for data from a pool of data storage resources (80 in FIG. 1). The data storage resources 80 may further comprise a cache 82. One of the processing elements 208 may manage cache resource allocation.

The processing elements 202-216, interconnect 300, and the data managers 280-286 may comprise a single integrated circuit comprising the STPP 200. Alternatively, processing elements 202-216, interconnect 300, and data managers 280-286 may comprise separate integrated circuits, with the interconnect 300 comprising channels 350 coupling the processing elements 202-216 and data managers 280-286.

If desired, at least one of the data structures 286 may have a message queue for facilitating communications between at least two of the processing elements 202-216. For example, one processing element 202 may send a message to the message queue 286 for another processing element 204 to retrieve.

If desired, at least one of the data structures 250-256 may be stored in a memory internal to the STPP 200. Alternatively, at least one of the data structures 250-256 may be stored in a memory that is external to the STPP 200.

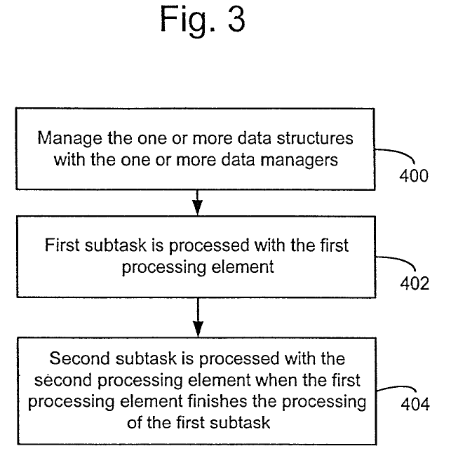

With reference to FIG. 3, a flow diagram illustrating the steps of a method performed by the system of FIGS. 1-2 is shown. The method comprises a step 400 of managing the one or more data structures 250-256 with the one or more data managers 280-286. A first subtask 152 is processed with the first processing element 202, as shown in step 402. The second subtask 154 is processed with the second processing element 204 when the first processing element 202 finishes the processing of the first subtask 152, as shown in step 404.

The data managers 280-286 provide intelligent access to the data structures 250-256 used by the processing elements. Each data manager 280-286 may act as a gateway to its associated data structure 250-256 and may accept high level commands to access and manipulate various fields, entries, and lists described in detail below.

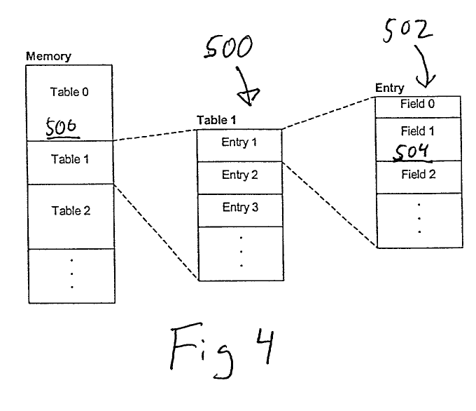

With reference to FIG. 4, the data structure 250-256 associated with each data manager 280-286 may be divided into multiple tables 500. Each table 500 is composed of multiple entries 502, and each entry 502 contains multiple fields 504. Each field 504 is a programmable number of bytes and can contain data or a pointer to another entry 504. Each table 500 can also be associated with one or more lists, where each list links together one or more entries 502 from the table 500.

The data managers 280-286 may support various types of lists, including tables, forward linked lists, double linked lists, and/or indirect linked lists.

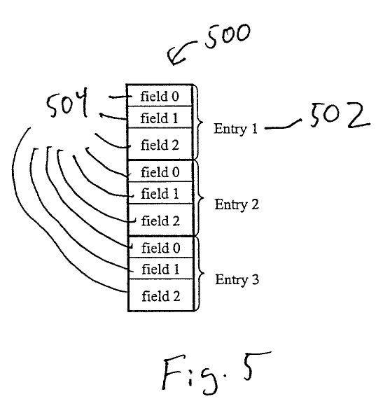

With reference to FIG. 5, an example structure of a table 500 is shown. A table 500 is the basic data structure used to partition memory. It is an array of entries 502, with each entry indexed by its position in memory. The following C code illustrates the code for this example structure of a table 500.

struct table_struct

| | |
|---|---|
| { | int field0; |
| | int field1; |
| | char field2 [4]; |
| }; | |

struct table_struct table [3];

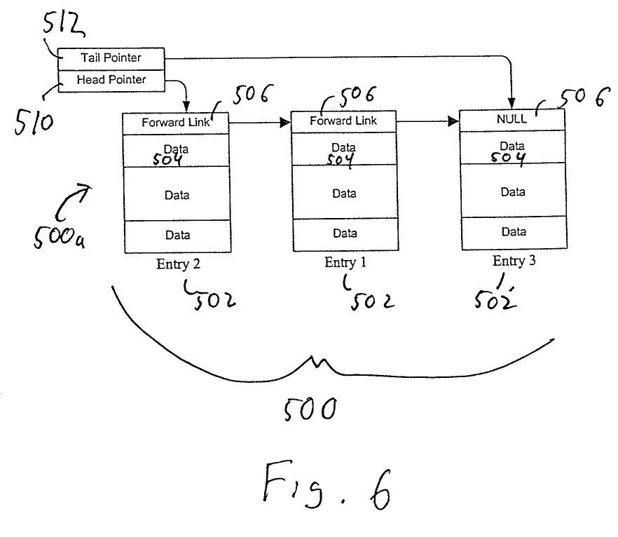

With reference to FIG. 6, an example structure of a forward linked list 500a, which may comprise a table 500, is shown. A forward linked list 500a is comprised of entries 502 from a table 500 linked together using link fields 506 that point to the next entry 502 in the list 500a. Each list also has a head and tail pointer 510 and 512 to identify the starting and ending entries 502 of the list 500a. The forward link in the list's 500a tail entry contains a NULL pointer 506a, indicating it is the last entry 502 in the list 500a.

When accessing the list 500a, each entry 502 may be indexed by its position in the table 500. There may not be a provision for accessing entries 502 by their relative position in the list 500a, other than starting at the head 510 and traversing the list 500a using the link fields 506. For example, in the FIG. 6, Entry 1, 502, is the first entry in the table 500, but it is the second entry 502 in the list.

Entries 502 can be inserted, removed, and moved by modifying the links—none of the data fields 504 need to be moved from one memory location to another. Note that to remove an entry 504, the previous entry's forward link 506 is modified. If the entry 502 to be removed is known, there is no easy way to find the previous entry 502 (other than traversing the entire list 500a from the beginning). For this reason, forward linked lists 500a work best for applications where entries 502 are always added to the tail 512 of the list 500a, and removed from the head 510 of the list 500a.

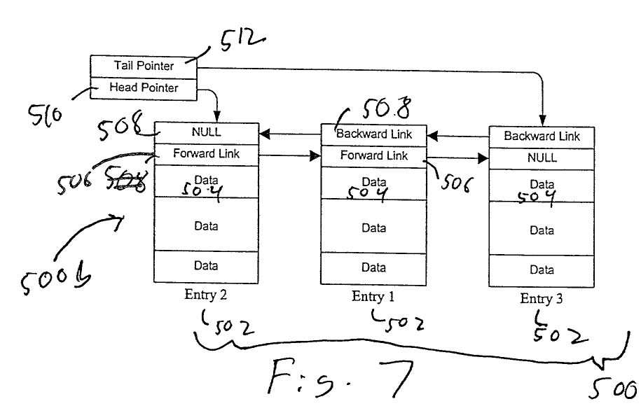

With reference to FIG. 7, a diagram illustrating an example of a double linked list 500b is shown. A double linked list 500b adds a backward link 508 to each entry 502. This makes it possible to traverse a list 500b backward as well as forward. This also makes it easier to add, remove, or move entries 502 from any location.

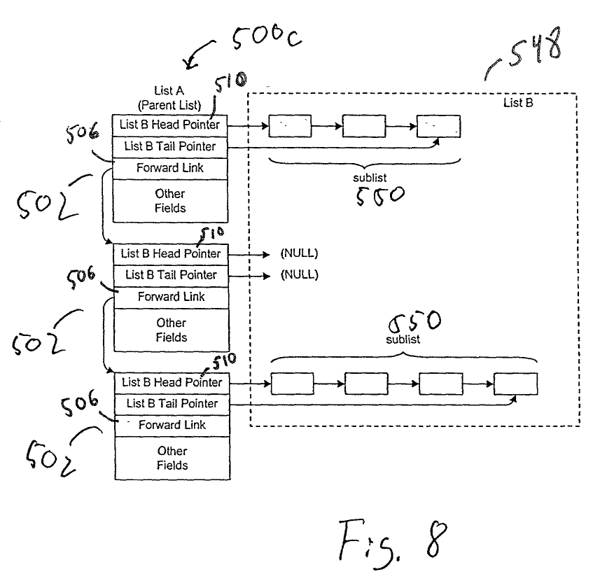

With reference to FIG. 8, a diagram showing an example structure of an indirect list 500c is shown. A list entry 502 may contain not only pointers to other entries 502 in the same list 500c, but also to entries in a different list 548. This secondary list 548 is called an indirect list 500c, and is composed of potentially thousands of sub-lists 550, each with a head and tail pointer in the parent list 548. An indirect list 500c may use entries 502 from the same table as a standard list 500—for example, new entries 502 for an indirect list 548 would be retrieved from a free list, which would be a separate standard list 500c.

A list descriptor, or list descriptor table, described below, for an indirect list 548 stores information about the primary list 500c and its pointers into the indirect list 548, and which fields 502 in the primary list 500c are the head and tail pointers 510 and 512. The only additional information required when using an indirect list 550 is which entry 502 in the parent list 500c is used to access the head and tail pointers 510 and 512.

Each entry 502 in a list 500c may contain one or more fields 504 designated as forward or backward links 506 (or 508 in FIG. 7). These links 506, 508 are maintained using the routines provided by the data manager 280-286. Routines for maintenance of lists are known to those skilled in the art. The head pointer 510 in the list descriptor table points to the first entry 502 in the list 500c. Following the forward pointer 506 leads to the next entry until the tail entry 502 is found. The backward pointer 508 of each entry 502 in the list points to the previous entry 502. If a forward link field 506 contains a value of 0, it is a NULL pointer and indicates the tail of the list 500c. Similarly, a NULL backward link 508 indicates the head of the list 500c. Note that because 0 is a NULL pointer, entries 502 in a table are numbered from 1 to n, rather than 0 to n−1. A field 504 used for a link may be, for example, 1-3 bytes in length.

Each table 500 optionally designates a field 502 as a key field. The data manager 280-286 provides commands to scan lists for a specific key field 502, and to build sorted lists using the key field 502 as the value to sort the list. The maximum size of a key field 502 is preferably 40 bits.

Tables 500 may optionally specify that each entry 502 contains a range. The range is composed of two fields 502 designated as the base and span. The range scan function can then be used to search a list for entries 502 overlapping a specified range. The size of the span field may not be larger than the size of the base field. In this example, the maximum size of the base field is 40 bits, and the maximum size of the span field is 32 bits.

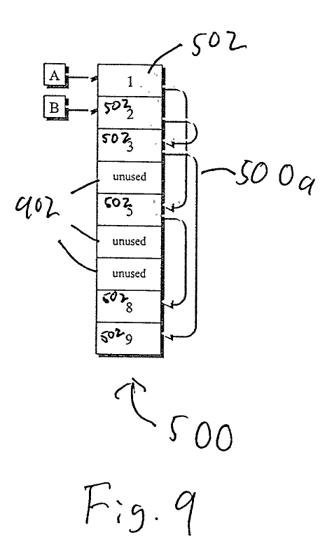

With reference to FIG. 9, an example structure of a multiple list in one table 500 is shown. It is possible to share the entries 502 of one table 500 among several different lists 500a. For instance, the message queues 256 for a processing element 202 and a processing element 204 may be placed in the same table 500. In the example in FIG. 9, the head of the message queue 256 for processing element 202 is at entry 1 indicated at A, while the head of the message queue 256 for processing element 204 is indicated at B as entry 2.

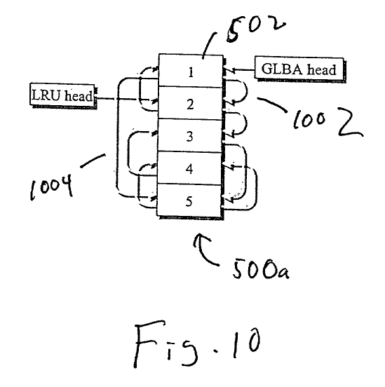

With reference to FIG. 10, another possible use for this capability is to link the same entries 502 in different orders. For example, there may be a list 500a containing all entries 502 sorted in one way, and another list 500a sorted another way, but including the same entries 502. Rather than creating two physically different lists 500a, one list is maintained with one set of links 1002, and the same list 500a has another set of links 1004 for a different sort.

In the example of multiple message queues 256 given above with respect to FIG. 9, several table entries 902 are marked as unused. This unused pool of table entries 902 is managed using a free list, which is simply a list of all the unused entries 902. Any time a processing element 202-216 needs to add a new entry 502 to a list, it takes an entry 502 from the head of the free list, and each time it removes an entry 502 from a list, it moves the entry 502 to the tail 512 of the free list. The free list has no special properties—to the data manager 286 it is seen as just one more list sharing the memory space. It has its own list descriptor, and is managed through the same commands used to manage all other lists.

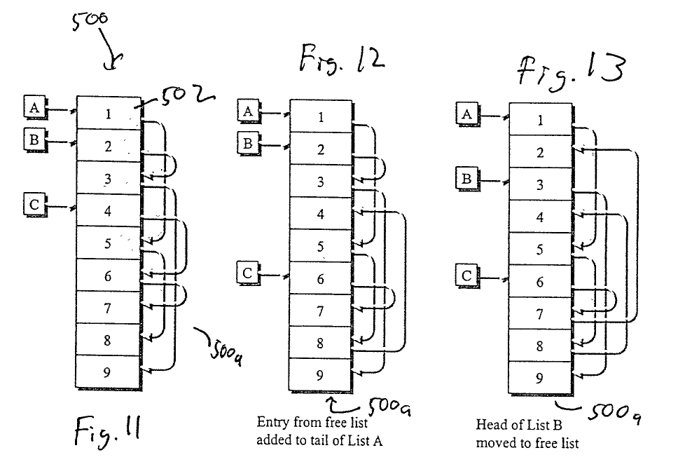

FIGS. 11-13 illustrate an example of free list usage. Lists starting at entries A and B contain the message queues 256 for two processing elements 202-216, and each processing element 202-216 has agreed that the list starting at entry c will contain the free list. Each time a field 504 is read or written, the processing element 202-216 specifies which list or table 250-256 contains the entry 502 to be accessed. In order to provide access to both lists 500a and tables 250-256 using the same command set, the data manager 280-286 numbers the tables from 0 to (num_tables-1), where num_tables is a parameter specified by firmware indicating the number of tables that have been defined. The lists 250-256 are numbered from (num_tables) to 255. When a command operates on a table 250-256 (specified list number<num_tables), it can perform simple operations such as reading and writing specific fields 504 in an entry 502. When a command operates on a list 500a (specified list number≧num_tables), it can perform additional operations such as reading/writing the head or tail entry of a list 500a; linking, unlinking, and moving entries 502 in a list 500a; and scanning lists for matching key fields 504 or ranges.

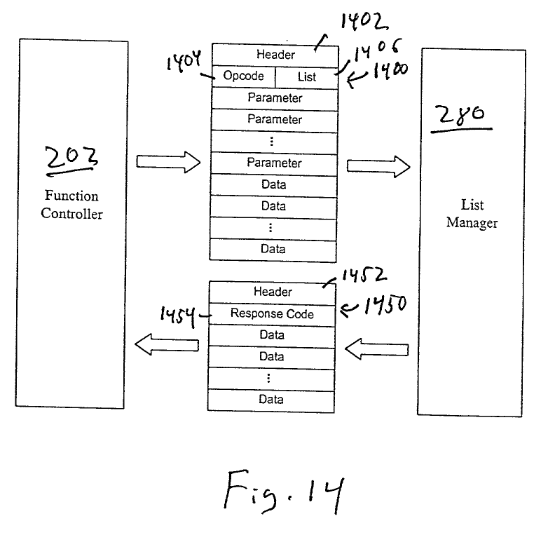

With reference to FIG. 14, the processing elements 202-216 send commands 1400 to the data manager 250-256 through the cross-point interconnect 300 as a packet of 16 bit words. The first word of the packet 1400 is a header 1402 containing routing and other information. The second word 1404 contains the command opcode 1404 in the most significant byte, and the list to be operated on in the least significant byte 1406. The data manager 280 is capable of receiving and queuing multiple commands 1400, but executes each command 1400 in the order it is received.

The command opcode 1404 received from the processing element 202 indicates whether the data manager 280 should send a response packet 145 after completing the command 1400. The response packet 1450 consists of two or more 16 bit words—the first word of the response packet 1450 is a header 1452 similar to the header 1402 received from the processing element 202, followed by a response code 1454 of the command 1400.

The data manager 280 may also send unsolicited response packets 1450. This allows the data manager 280 to notify a processing element 202 when the number of entries 502 in a list 500a has passed a certain threshold. Processing elements 202-216 can keep track of whether their message queues 256 are empty using this protocol. Another use is to create a notification event when the number of dirty cache state directories exceeds a certain threshold.

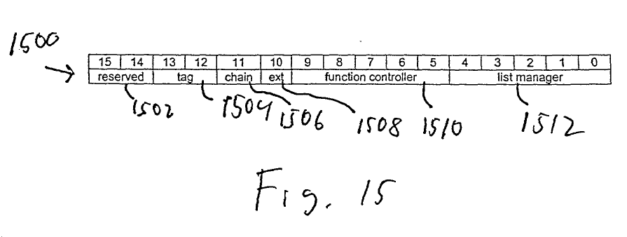

With reference to FIG. 15, an exemplary header 1500 for a command packet 1400 or a response packet 1450 is shown. A reserved field 1502 is echoed back to the processing element 202 in the response code, but is otherwise ignored by the data manager 280. The tag field 1504 is used by processing element 202 to keep track of multiple outstanding commands 1400. The data manager 280 ignores the tag field 1504 on received commands 1400. When generating an event notification, the data manager 280 sets this field to ‘11’. An event consists of an occurrence, such as a new entry 502 being added to a message queue list 256. This way, a processing element 202 would be notified of a new entry 502 to a message queue list 256.

A chain bit 1506 indicates to the cross point switch that it should not re-arbitrate after the current packet 1400 completes, allowing multiple commands 1400 to be sent automatically to the data manager 280. This allows a processing element 202 to chain commands, uninterrupted by commands from other processing elements 204-216. The data manager 280 uses this bit to abort all subsequent chained commands 1400 if a chained command 1400 fails. This bit is cleared in the response packet 1450.

An external byte 1508 indicates whether a command 1400 originated from an off-chip processing element 202, or an on-chip processing element 202. The data manager 280 ignores this field. When the cross point interconnect 300 consists of two interconnects, 300a and 300b, then the origin of the command can be ascertained from the external bit 1508. For example, if a command originated from a processing element 202 connected to interconnect 300a, then the external byte may be set to ‘01’, otherwise, if from 300b, it may be set to ‘11’.

For commands 1400, a function controller field 1510 indicates which processing element 202-216 sent the command. For responses 1450, the function controller field 1510 is used to specify where to send the response 1450.

A data manager field 1512 contains the identification of the data manager 280.

Each time the data manager 280 executes a command 1400 that changes the number of entries 502 on a list 500a, it can compare the number of entries 502 on the list 500a to a specified threshold. The data manager 280 generates a response packet 1450 if the number of entries 502 on the list 500a reaches a minimum threshold after being decremented or reaches a maximum threshold value after being incremented.

One or more of these events can be used to generate a response packet 1450—this is controlled through the list descriptor. When the data manager 280 sends a packet 1450 to a processing element 202, the first word after the header is the response code 1454. This response code 1454 is used to indicate successful completion of a command 1400, command errors, and event notification.

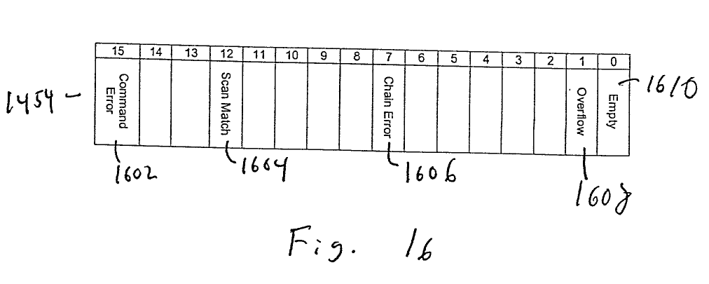

With reference to FIG. 16, the structure of a response code 1454 is shown. The response code 1454 contains a command error bit 1602. If this bit is a ‘1’, the command 1400 completed with an error. If this bit is a ‘0’, the command 1400 completed without an error.

A scan match bit 1604 indicates whether a scan command found a match in a scan operation in, for example, a stored data file.

A chain error bit 1606 indicates whether the current command 1400 was aborted because the previous chained command 1400 did not complete successfully.

An overflow bit 1608 indicates whether an increment or decrement operation caused a field 504 to overflow.

An empty bit 1610 may indicate an error such as whether an attempted read/write access was made to the head or tail of an empty list 500a, or attempt to unlink an entry 502 from an empty list 500a.

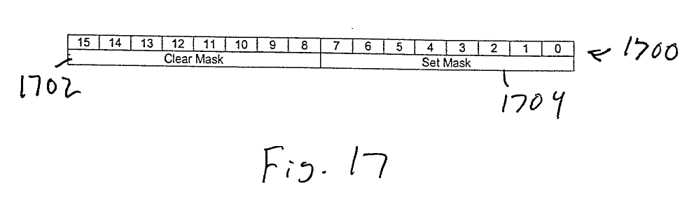

With reference to FIG. 17, an asynchronous message response code 1700 is shown. The response code 1700 contains a value specified by a microprocessor for the list 500a. The least significant byte contains a mask 1704 indicating which asynchronous message bits in the processing element to set, and the most significant byte 1702 indicates which bits to clear.

Table 1 illustrates a summary of example commands 1400.

| Opcode | Command | Description |
|---|---|---|
| 01 | Read_Seq | Reads sequential fields from an entry. |
| 05 | Read_Rand | Reads non-sequential fields from an entry, using a bitmask |
| | | to specify which fields should be returned. |
| 11 | Write_Seq | Writes sequential fields to an entry. |
| 15 | Write_Rand | Writes non-sequential fields to an entry, using a bitmask to |
| | | specify which fields should be written. |
| 25 | Copy_Rand | Copies non-sequential fields from an entry in one list to an |
| | | entry in another list, using a bitmask to specify which fields |
| | | to copy. |
| 30 | Modify_Field | Sets and clears bits within a field. |
| 38 | Inc_Field | Increments a field. |
| 39 | Dec_Field | Decrements a field. |
| 40 | Link | Links an entry into a list. |
| 41 | Link_Indirect | Links an entry into an indirect list. |
| 42 | Link_Sort | Inserts an entry into a sorted list. |
| 43 | Link_Sort_Indirect | Inserts an entry into a sorted indirect list. |
| 44 | Link_Multiple | Links a sublist of linked entries into a list. |
| 48 | Unlink | Removes an entry from a list. |
| 49 | Unlink_Indirect | Removes an entry from an indirect list. |
| 50 | Move | Moves an entry from one list to another. |
| 51 | Move_from_Indirect | Moves an entry from an indirect list to a standard list. |
| 53 | Move_to_Indirect | Moves an entry from a standard list to an indirect list. |
| 54 | Move_Sort | Moves an entry from one list into a sorted list. |
| 55 | Move_Sort_Indirect | Moves an entry from one list into a sorted list, one of the |
| | | lists is indirect. |
| 60 | Get_Num_Entries | Returns the number of entries on the list. |
| 62 | Get_Head | Returns the head pointer of a list. |
| 63 | Get_Tail | Returns the tail pointer of a list. |
| 70 | Key_Scan | Searches a list for a key field. |
| 71 | Key_Scan_Sort | Searches a sorted list for a key field. |
| 78 | Range_Scan | Searches a list for base + span fields that create a range that |
| | | overlaps with the specified base + span. |

The majority of data manager commands 1400 should be able to complete without error, and it is anticipated that most errors that occur will be the result of programming bugs in the processing element 202, which has writeable control storage code and contains micro-code executable on the processing element 202. For this reason, the list 500a treats most errors as fatal—it will stop accepting commands 1400 from the interconnect 300 and interrupt the microprocessor. When debugging the chip, this will provide an immediate indication of a problem, and make it easier to track down bugs.

There are a few errors that may not cause the data manager 280 to halt. One such error is attempting to read the head or tail of an empty list 500a. While the data manager 280 has built-in capability to indicate to a processing element 202 when a list 500a is empty, there is a delay from removing a list's last entry 502 to the empty status being communicated to the processing element 202. If the processing element 202 cannot tolerate this delay, it may issue a new read command 1400 before it has been notified the list 500a is empty. Other such non-fatal errors include attempting to write the head or tail of an empty list 500a or attempting to move or unlink the head or tail of an empty list 500a. If the error is from command 1400 with a response request, an error is returned to the processing element 202, and the processing element 202 is expected to handle the error. If the error is from a command 1400 that does not have a response request, the data manager 280 stops and the microprocessor is interrupted. If the error resulted from a command 1400 with a response request in a chained command 1400, the command 1400 is aborted and the next chained command 1400 is aborted also. One error is returned to the processing element 202 after the last chained command 1400 is received.

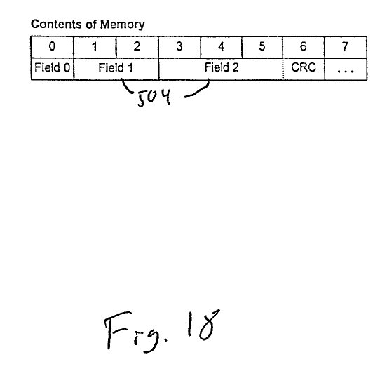

With reference to FIG. 18, fields 504 may be any length, for example, from 1 to 32 bytes, and are packed in memory on byte boundaries to conserve space. When communicating with the processing elements 202-216, the values are unpacked and transferred as one or more 16 bit words. Any fields larger than 16 bits are transferred in multiple clock cycles with big endian ordering, which is an order of bytes in a word in which the most significant byte or digits are placed leftmost in a structure. Fields 504 that do not fit exactly in a multiple of 16 bits are padded with zeros to extend their size to 16, 32, 48, etc. bits. When a field 504 contains a cyclical redundancy checking (CRC) value, the data manager 280 adds the CRC to the field 504 when writing to memory, and checks and strips the CRC from the data when reading from memory.

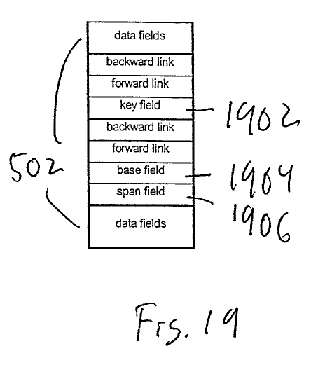

The backward link field 508, if present, is the field immediately preceding the forward link field 506. A key field is the field immediately following the forward link, which is used for list searches and entry identification. For a range, the base immediately follows the forward link 506, and the range follows the base. FIG. 19 illustrates an example of a table entry 502 that supports one list 500a with a key field 1902, and a list 500a with separate links and base and span fields 1904 and 1906.

CRC check bits can be specified for each field 504 handled by the data manager 280. The following bit definitions are supported for the CRC Type:

| CRC | CRC | |
|---|---|---|
| Descriptor | Type | Polynomial |
| 00 | No CRC | — |
| 01 | CRC-4 | x⁴ + x + 1 |
| 10 | CRC-5 | x⁵ + x² + 1 |
| 11 | CRC-8 | x⁸ + x² + x + 1 |

CRC-5 is not recommended for any field larger than 4 bytes.

Each time a field 504 is written, the data manager 280 appends CRC to the field 504 in memory. When the data manager 280 reads a field 504, it checks the CRC and strips it off before giving the field data to the processing element 202. If a CRC error is detected, the data manager 280 halts all operations and gives an interrupt to its internal microprocessor. The microprocessor then performs all error recovery necessary to allow the data manager 280 to resume executing commands 1400 from the processing elements 202-216. The microprocessor may turn off the CRC engine, allowing it to read and write both the data and CRC portions of a field 504.

The field descriptor table describes the location, length, and CRC protection for all the fields 504 in each list contained in the data manager 280. The field descriptor table is accessible only by the microprocessor. An example of a field descriptor table follows:

| 7 6 5 4 3 2 1 0 | 4 3 2 1 0 | 1 0 | | |
|---|---|---|---|---|
| Field Offset | Length | CRC | | |
| Field Offset | Length | CRC | | |
| Field Offset | Length | CRC | {close oversize brace} | Descriptors for Table 0 |
| Field Offset | Length | CRC | | |
| Field Offset | Length | CRC | | |
| Field Offset | Length | CRC | | |
| Field Offset | Length | CRC | {close oversize brace} | Descriptors for Table 1 |
| Field Offset | Length | CRC | | |
| . | . | . | | |
| . | . | . | | |
| . | . | . | | |

Each field descriptor is composed of three values:

| | |
|---|---|
| Field Offset | The relative byte offset (0-255) of the field |
| | from the beginning of the entry 502. |
| Length | The number of bytes (minus 1) contained in the field 504, |
| | including CRC bits. (1-32) |
| CRC Type | Specifies the CRC format, if any, of the field 504. |

A notify table stores all the notify thresholds for all lists 500a. Each list 500a indexes into this table for its notify thresholds. An example of the notify table follows:

| | | | |
|---|---|---|---|
| Destination | Bit | Action | Threshold |
| Destination | Bit | Action | Threshold |
| Destination | Bit | Action | Threshold |
| . | . | . | . |
| . | . | . | . |
| . | . | . | . |

Each notify descriptor is composed of the following values:

| | |
|---|---|
| Destination | Specifies which processing element 202-216 to send the |
| | asynchronous message to. This is a six bit value which is |
| | put into bits 10:5 of the packet header (note that the |
| | most significant bit of this value is the “external” |
| | bit in the packet header). |
| Bit | Specifies which asynchronous message register bit to |
| | set or clear in the processing element 202. This is |
| | a three bit value specifying one of eight bits. |
| Action | This specifies what to do when a threshold is met. |
| Threshold | Holds a threshold size or value for a list 500a. |

The following chart illustrates some example action codes:

| Action | |
|---|---|
| 000 | Disabled |
| 001 | Disabled |
| 010 | Clear when # entries ≦ threshold |
| 011 | Set when # entries ≦ threshold |
| 100 | Set when # entries > threshold |
| 101 | Clear when # entries > threshold |
| 110 | Set when >, clear when ≦ |
| 111 | Clear when >, set when ≦ |

The table descriptor defines how the memory is partitioned. The following chart illustrates the parameters for each table descriptor describing the table:

| | Size | |
|---|---|---|
| Parameter | (bits) | Description |
| Base Address | 26 | Memory address of entry 0 in the table. Note |
| | | that since the first entry in a table is entry 1, |
| | | this points one entry ahead of the first entry. |
| Bytes Per Entry | 8 | The number of bytes contained in a table |
| | | entry. |
| Max Field | 8 | Maximum legal field index. |
| Max Entries | 20 | Maximum legal entry number. Memory used |
| | | by table = MaxEntries * BytesPerEntry. |
| Field 0 | 8 | The index of the field descriptor for field 0. |
| Descriptor Index | | |
| Num Entries | 20 | The number of entries linked in the list. |
| Notify Index | 6 | Index into the Notify Table for generating |
| | | asynchronous messages to the function |
| | | controllers. |
| Notify Count | 3 | Number of entries in the Notify Table for the |
| | | current list. |
| Head Pointer | 20 | The entry number of the head of a linked |
| Indirect Head | | list.—Or—If the list is indirect as specified by |
| List, Field | | the Ind bit, Bits 7-0 specify the FieldIndex to |
| | | be used as the HeadPointer, and Bits 15-8 |
| | | specify the table containing the head pointer. |
| Tail Pointer | 20 | The entry number of the tail of a linked |
| Indirect List Tail | | list.—Or—If the list is indirect as specified |
| Field | | by the Ind bit, Bits 7-0 specify the FieldIndex |
| | | to be used as the Tail Pointer. |
| Forward Link | 8 | The field used as a forward link to the next |
| | | entry in the linked list. If this value is FFh, |
| | | the list is not forward linked. |
| Backward Link | 1 | If this bit is 0, the list is not double linked. If |
| | | this bit is 1, the backward link is the field |
| | | immediately preceding the forward link. |
| Table | 5 | The table containing the entries in the list. |
| Indirect Flag | 1 | This bit, when set, indicates that the Head and |
| | | Tail pointers are fields in an entry of another |
| | | list. The entry is specified as a parameter of |
| | | the LinkIndirect, MoveIndirect, and |
| | | UnlinkIndirect commands. |

The address in memory of a list entry 502 is:
Base Address + (Bytes Per Entry * Entry) + Field Offset

There are several steps used to get all the information necessary for the calculation:

1. Given a list number, read the list descriptor for that list. This provides the head and tail pointer (if you need to reference the head or tail of the list), and the index into the table descriptor.

2. Read the table descriptor. This provides the base address, bytes/entry, and the index into the field descriptor.

3. Read the field descriptor. This provides the field offset.

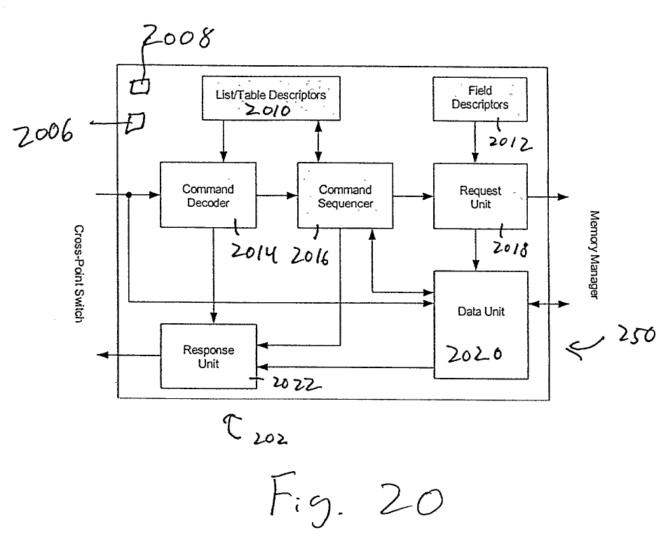

With Reference to FIG. 20, a block diagram illustrating the structure of a data manager 250 is shown. The data manager 250 contains list and table descriptors 2010 that store configuration information for the tables 250-256 and lists 500a. Field descriptors 2012 store configuration of fields in the tables 250-256 and lists 500a. A command decoder 2014 accepts commands 1400 from the interconnect 300. The command decoder 2014 parses commands 1400 into opcodes and parameters which can be stored in registers. The command decoder 2014 contains blocks of logic with processing units that are programmable. A command sequencer 2016 implements the commands 1400 once parsed. The command sequencer 2016 performs tasks such as calculating formulas as directed by the commands 1400. For example, a formula for calculating an offset for a memory address may be performed by the command sequencer 1400. A request unit 2018 propagates and processes requests to the associated list 250. A data unit 2020 stores incoming data from the list 250. The command sequencer 2016 may perform further functions on the incoming data in the data unit 2020 before the data is forwarded to a response unit 2022, which propagates the retrieved data into the cross point switch 300 to the proper processing element.

With reference to FIG. 21, a block diagram illustrating example components of a processing element 202 is shown. Each processing element 202-216 (generally indicated at 202 in FIG. 21) comprises a processor 2102 that may be either a reduced instruction set chip (RISC) or a complex instruction set chip (CISC) known to those skilled in the art.

A memory space having writeable control storage (WCS) 2108, which contains micro-code executable on the processing element 202 is included in the processing element 202 for processing the particular subtask 152-156 that the processing element 202 is to process. By updating the instruction set in the WCS 2108, the processing element 202 may be re-configured to process a different subtask 152-156.

An interconnect interface 2112 is included with the processing element 202 that consists of two main blocks, an interconnect to processing element component 2112a to control the data in from the interconnect 300 to a register bank 2120, and processing element to interconnect component 2112b to control the data out from the register bank 2120 in the processing element 200 to the interconnect 300.

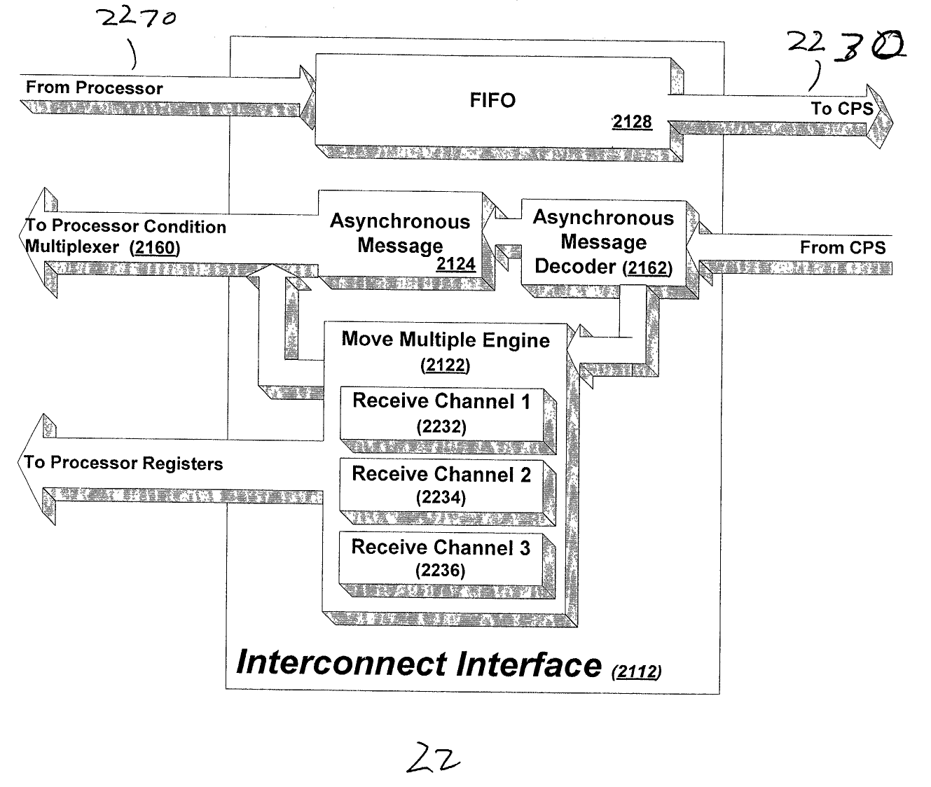

The processing element to interconnect component 2112a comprises a move multiple machine 2122, and an asynchronous message decoder 2162. The move multiple machine 2124, described in more detail with respect to FIG. 22, interrupts the current instruction and performs a move-multiple instruction to the desired register location in register bank 2120.

The processing element 202 may also contain, or have a bus for connecting to, custom logic 2106. The custom logic 2106 may be used to optimize the processing element 202 for processing the subtasks 152-156.

With reference to FIG. 22, a block diagram illustrates the interface to the interconnect 2112, and comprises a FIFO 2128, an interface 2270 between the register bank and the FIFO 2128, and an interface 2230 between the FIFO 2128 and the interconnect 300. The interface between the FIFO and the interconnect 2130 manages the protocol of the interconnect 300. The FIFO 2128 level is also monitored to stall the transfer to or from the interconnect 300 should the FIFO 2128 become empty or fall.

The FIFO 2128 contains the packets 1400 or 1450 being transferred to/from the interconnect 300. The FIFO 2128 also contains an extra bit for each word that indicates the last word of the packet 1400 or 1450; when the bit is a one, the associated word is the last in the packet. This last transfer indicator is available to an arithmetic logic unit (ALU) (2150 IN FIG. 21) for condition checking, and also is used by the error detection logic to detect under and overruns in the FIFO 2128. Two address pointers keep track of the transfers by the interconnect 300 and the executable instructions in the WCS 2108. A separate counter keeps track of the number of words in the FIFO 2128 for full/empty status.

For sending commands 1400 to the data managers 280-286, the interface 2112 between the processing element 202 and the interconnect 300 has a FIFO 2128 for stacking command packets 1404 for forwarding to the data managers 280-286 through the interconnect 300.

An asynchronous message decoder 2162 is used for receiving response packets 1450 and asynchronous message response codes (1700 shown in FIG. 17), and routing the response codes 1700 into the asynchronous message decoder 2162 and response codes 1700 into a move multiple engine 2122 that performs move-multi instructions.

One exemplary instruction that may be part of the WCS 2108 comprises a move multiple command. The move multiple command allows for a convenient way to specify the transfer of a group of data. The move multiple command (move-multi) allows the user to specify the source and destination as either a group from one memory address, a group from consecutive addresses, or a group from non-consecutive address, all referenced from a starting address.

One type of transfer performed by the multi-multi command is called a group-of-one transfer. A group-of-one transfer is a transfer of data from or to a channel 2232-2236 that is referenced by one address. Many words of data may be transferred with one address being specified. A channel 2232-2236 may be used to transfer data from a data manager 280-286, another processing element 202-216, or a device external to the STPP 200.

Another type of transfer performed is a group-of-many transfer, which is used to transfer data from or to consecutive addresses. Using move-multi, one or more registers are specified with the starting address and the number of transfers to occur.

Yet another type of transfer is a group-of-many transfer in which registers at non-sequential addresses can be transferred with a move-multi. By employing a bit-mapping mode, the processing element 202 may transfer registers. The bit-map of the registers can be specified to transfer data referenced from the starting address.

The move-multi command processes data from the move multiple engine 2122 wherein a move transfer can occur from one-to-one, one-to-many, or many-to-one addresses. For example, with the move multiple command, the interconnect 300 can transfer many general-purpose registers in consecutive or bit-mapped addresses. Or, for instance, consecutive or bit-mapped registers can be moved through the interconnect 300 with the move-multiple command. Also, general-purpose registers in bit-mapped or consecutive address order can be moved to another set of bit-mapped or consecutive addresses.

Similarly to the move-multiple command, a move multiple table command (MMT) allows for a convenient way to specify the transfer of a table entry 502. MMT is tailored only for a table move. MMT has a larger address field that can access the address ranges: 0000-3fff and C000-F000 directly. The MMT command differs from the move-multiple command in the respect that it does not allow for the source, the table, to be a port; and that is there is no multi bit for the source.

When a response packet 1450 is initiated into the FIFO 2128 the, tag (1504 in FIG. 15) has been set to indicate which channel will be used in the move multiple machine 2122. One or more of a plurality of channels 2232-2236 is configured to route one or more corresponding data from the response packets 1450 to the proper microprocessor registers. The move multiple engine 2122 is useful because response packets 1452 may not return in the same order that the command packets 1400 were generated and transmitted to the list managers 280-286 through the interconnect 300. As each response packet 1452 is received from the interconnect 300, the data from the response packet 1452 is received through the corresponding channel 2232-2236, and the processor 2102 is interrupted to branch to move multiple instruction to process the response data.

An asynchronous message register 2124 is provided in the interconnect interface 2112 and receives asynchronous messages response codes 1700 from the asynchronous message decoder 2162 which routes said messages from the data managers 280-286. The asynchronous message response code 1700 indicates that a threshold condition has been met for a particular list 250-256. Bits are set and cleared in the asynchronous message register 2124 to so indicate. A condition multiplexer (2160 in FIG. 21) is included in the processing element 202 for monitoring the bit status in the asynchronous status register 2232. The condition multiplexer 2160 allows the processor to branch conditionally to handle said threshold condition. An example of this was discussed above with regard to message queues 256. The asynchronous message register 2124 may indicate that a message queue 256 has an entry 502.

A preferred scalable transaction processing pipeline system, and many of its attendant advantages, have thus been disclosed. It will be apparent, however, that various changes may be made in the components of the system and arrangement of the steps of the process without departing from the spirit and scope of the invention, the system and method hereinbefore described being merely preferred or exemplary embodiments thereof. Therefore, the invention is not to be restricted or limited except in accordance with the following claims and their legal equivalents.

What is claimed is:

1. A system for processing a task having a plurality of component subtasks including a first subtask and a second subtask, the system comprising:
a plurality of processing elements including a first processing element and a second processing element, the first processing element adapted to process the first subtask of the task, the second processing element adapted to process the second subtask of the task;
a plurality of data structures;
a plurality of data managers, each data manager adapted to manage a data structure; and
an interconnect that couples each processing element to at least one data manager;
wherein the first processing element processes the first subtask of the task, and when the first processing element finishes the processing of the first subtask, the second processing element processes the second subtask of the task.

2. The system of claim 1 wherein at least one of the data structures comprises a list, and wherein at least one data manager is optimized to manipulate the list.

3. The system of claim 1 wherein at least one of the data structures comprises a table, and wherein at least one data manager is optimized to manipulate the table.

4. The system of claim 2 wherein the processing elements send packets to the data managers via the interconnect, the packets containing list-manipulation commands.

5. The system of claim 1 wherein the second processing element is adapted to process the second subtask of the task while the first processing element processes the first subtask of a next task.

6. The system of claim 1 wherein each processing element is optimized to process a subtask of the task.

7. The system of claim 1 wherein each data manager is optimized to manage a data structure.

8. The system of claim 1 wherein each processing element is adapted for processing a different subtask of the task.

9. The system of claim 1 wherein two or more processing elements comprise a first subset of the plurality of processing elements, wherein the first subset is adapted for processing a selected subtask of the plurality of subtasks, wherein each processing element of the first subset is adapted to process a portion of the selected subtask.

10. The system of claim 1 wherein the task includes a request for data from a pool of data storage resources.

11. The system of claim 1 wherein the interconnect includes a partial crosspoint interconnect.

12. The system of claim 1 wherein the interconnect includes a crossbar.

13. The system of claim 1 wherein the interconnect comprises a first and second interconnect, wherein at least one of the processing elements is coupled to the first interconnect and at least one data manager is coupled to the second interconnect, wherein the first interconnect is coupled to the second interconnect thereby coupling the processing element coupled to the first interconnect with the data manager coupled to the second interconnect.

14. The system of claim 1, wherein the system is for processing a plurality of ordered task_{1 to N}, each taskₙ having a plurality of ordered subtasks_{1 to M}, each subtaskₘ to be processed by at least one processing elementₘ of a plurality of processing elements_{1 to M}, wherein while a processing elementₘ processes a subtaskₘ of a taskₙ₊₁, a processing elementₘ₊₁ processes a subtaskₘ₊₁ of a taskₙ, wherein the taskₙ is the task immediately preceding the task_{n+1,}and wherein the subtaskₘ is the subtask immediately preceding the subtaskₘ₊₁.

15. The system of claim 1, wherein a second subset of the plurality of processing elements is adapted to process one of the plurality of subtasks for a plurality of tasks in parallel.

16. The system of claim 1 wherein at least one of the processing elements decodes commands.

17. The system of claim 1 wherein at least one data structure is a cache state and at least one of the processing elements controls a cache state.

18. The system of claim 1 wherein at least one of the processing elements maps data addresses to logical block addresses of a disk drive.

19. The system of claim 1 wherein at least one of the processing elements interacts with a host.

20. The system of claim 1 further comprising a cache wherein one of the processing elements manages cache resource allocation.

21. The system of claim 1 further wherein the processing elements, interconnect, and the data managers comprise a single integrated circuit.

22. The system of claim 1 wherein at least one of the data structures has a message queue for facilitating communications between at least two of the processing elements, wherein one processing element sends a message to the message queue for the other processing element to retrieve.

23. The system of claim 1 wherein at least one data structure is stored in an internal memory.

24. The system of claim 1 wherein at least one data structure is stored in an external memory.

25. The system of claim 1 wherein the tasks are selected from the group consisting of: RAID requests; queue management commands, cache data request, read data requests, write data requests, block level read requests, block level write requests, file level data read requests, file level data write requests, directory structure commands, and database manipulation commands.

26. In a system having a plurality of processing elements including a first processing element and a second processing element; a plurality of data structures; a plurality of data managers, each data manager adapted to manage a data structure; and an interconnect coupling each processing element to at least one data manager, a method for processing a task having a plurality of component subtasks including a first subtask and a second subtask, each subtask corresponding to at least one processing element adapted to process the subtask, the method comprising:
managing one or more data structures with one or more data managers;
processing the first subtask with the first processing element;
processing the second subtask with the second processing element when the first processing element finishes the processing of the first subtask.

27. The method of claim 26 wherein at least one of the data structures comprises a list, and wherein at least one data manager is optimized to manipulate the list.

28. The method of claim 26 wherein at least one of the data structures comprises a table, and wherein at least one data manager is optimized to manipulate the table.

29. The method of claim 27 wherein the processing elements send packets to the data managers via the interconnect, the packets containing list-manipulation commands.

30. The method of claim 26, comprising processing the second subtask of the task with the second processing element while the first processing element processes the first subtask of a next task.

31. The method of claim 26 wherein each processing element is optimized to process a subtask of the task.

32. The method of claim 26 wherein each data manager is optimized to manage a data structure.

33. The method of claim 26 wherein each processing element is adapted for processing a different subtask of the task.

34. The method of claim 26, further comprising processing a selected subtask of the plurality of subtasks with two or more processing elements comprising a first subset of the plurality of processing elements, wherein each processing element of the first subset is adapted to process a portion of the selected subtask.

35. The method of claim 26 wherein the task includes a request for data from a pool of data storage resources.

36. The method of claim 26 wherein the interconnect includes a partial crosspoint interconnect.

37. The method of claim 26 wherein the interconnect includes a crossbar.

38. The method of claim 26 wherein the interconnect comprises a first and second interconnect, wherein at least one of the processing elements is coupled to the first interconnect and at least one data manager is coupled to the second interconnect, wherein the first interconnect is coupled to the second interconnect thereby coupling the processing element coupled to the first interconnect with the data manager coupled to the second interconnect.

39. The method of claim 26, comprising processing a plurality of ordered tasks_{1 to N}, each taskₙ having a plurality of ordered subtasks_{1 to M}, each subtaskₘ to be processed by at least one processing elementₘ of a plurality of processing elements_{1 to M}, wherein while a processing elementₘprocesses a subtaskₘ of a taskₙ, a processing elementₘ₊₁ processes a subtaskₘ₊₁ of a taskₙ₊₁, wherein the taskₙ is the task immediately preceding the taskₙ₊₁, and wherein the subtaskₘ is the subtask immediately preceding the subtaskₘ₊₁.

40. The method of claim 26, further comprising processing one of the plurality of subtasks for a plurality of tasks in parallel using a second subset of the plurality of processing elements, each of the processing elements of the second subset adapted to process the same subtask for a plurality of tasks.

41. The method of claim 26 comprising decoding commands with at least one of the processing elements.

42. The method of claim 26 comprising controlling at least one data structure comprising cache state.

43. The method of claim 26 comprising mapping addresses to logical block addresses with at least one of the processing elements.

44. The method of claim 26 wherein at least one of the processing elements interacts with a host.

45. The method of claim 26 comprising managing resource allocation of a cache with at least one of the processing elements.

46. The method of claim 26 facilitating communications between at least two of the processing elements with a message queue, wherein one processing element sends a message to the message queue for the other processing element to retrieve.

47. The method of claim 26 comprising storing at least one data structure in an internal memory.

48. The method of claim 26 comprising storing at least one data structure in an external memory.

49. The method of claim 26 wherein the tasks are selected from the group consisting of: RAID requests, queue management commands, cache data request, read data requests, write data requests, block level read requests, block level write requests, file level data read requests, file level data write requests, directory structure commands, and database manipulation commands.
